(19) United States
(12) Patent Application Publication
(10) Pub. No.: US 2025/0202889 A1
(43) Pub. Date: Jun. 19, 2025

(54) ACCOUNT LOCKOUT PREVENTION WITH MULTIFACTOR AUTHENTICATION

(71) Applicant: MOTOROLA MOBILITY LLC, WILMINGTON, DE (US)

(72) Inventors: KRISHNAN RAGHAVAN, BANGALORE (IN); NAKUL PATEL, NAGPUR (IN); A G PRASAD, BANGALORE (IN)

(21) Appl. No.: 18/544,291

(22) Filed: Dec. 18, 2023

(51) Int. Cl. H04L 9/40

(52) U.S. Cl. CPC H04L 63/0838

(57) ABSTRACT

A method provides techniques for account lockout prevention with multifactor authentication. The method includes detecting, by an electronic device that comprises a memory having stored thereon at least one application requiring login authentication to an account via an account unlock module, a number of failed access attempts for access to the account based on a first challenge. In response to the number of failed access attempts exceeding a failed account access attempt limit, access to the account via the first challenge is temporarily suspended. An alternate challenge requiring entry of a second, different authentication response is presented. The method continues with enabling further access to respond to the first challenge only in response to receipt of a correct response to the alternate challenge.

### BACKGROUND

### 1. Technical Field

The present disclosure generally relates to electronic communication devices that provide authenticated access to electronic accounts, and more specifically to electronic communication devices that support multifactor authentication to provide authenticated access to electronic accounts.

### 2. Description of the Related Art

Multifactor authentication (MFA) provides an additional layer of security beyond just using a username and password to access an electronic account. MFA adds an extra layer of protection by requiring users to provide multiple forms of authentication, making it more difficult for unauthorized individuals to access accounts. Thus, even if one factor (e.g., a password) is compromised, an additional factor (e.g., a one-time passcode sent to a mobile device) adds another barrier for account access, reducing the risk of unauthorized access. MFA helps mitigate the impact of stolen or compromised passwords, by requiring the attacker with the stolen/compromised password to also have the additional authentication factor to gain access to the account. For remote access scenarios, MFA adds an extra layer of security, making it more challenging for attackers to compromise accounts, especially when users are logging in from different locations or devices. Thus, multifactor authentication is a powerful tool for enhancing security by adding multiple layers of protection, reducing the risk of unauthorized access, and addressing various security challenges in protecting online accounts.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of an electronic device with specific components used to enable the device to perform functions of account lockout prevention via multifactor authentication, according to one or more embodiments;

FIG. 2 illustrates a user interface sequence for initiating presentation of an alternate challenge in lieu of an account lockout, following a first number of unsuccessful account access attempts, according to one or more embodiments;

FIG. 3 illustrates a user interface sequence that includes entry of a correct response for an alternate challenge followed by presentation of additional attempt(s) to enter a first login authentication, according to one or more embodiments;

FIG. 4 illustrates a user interface sequence for indicating account lockout following a maximum number of unsuccessful access attempts, including attempts enabled post two factor authentication, according to one or more embodiments;

FIG. 5 illustrates an exemplary user interface for configuring the account lockout prevention feature for a user account, according to one or more embodiments;

FIG. 6 depicts a flowchart of a method for account lockout prevention with multifactor authentication, according to one or more embodiments; and

FIG. 7 depicts a flowchart of a method for establishing a failed account access attempt limit based on a use context, according to one or more embodiments.

### DETAILED DESCRIPTION

According to aspects of the present disclosure, an electronic device, a method, and a computer program product provides techniques for account lockout prevention via use of multifactor authentication. One or more embodiments can include detecting a number of failed access attempts for access to an account based on a first challenge. In response to the number of failed access attempts exceeding a first failed account access attempt limit, access to the account is temporarily suspended. While the account is temporarily suspended, the user is presented with an alternate challenge that requires entry of a second, different authentication response. Further access to respond to the first challenge is enabled only in response to receipt of a correct response to the alternate challenge.

Access to an online or electronic account is usually protected by use of a secure login that requires entry of a passcode or password in an account login portal. These secure login processes often limit the number of incorrect access attempts, and once that limit is exceeded, the account may become locked to protect the account. Implementing an account lockout policy after a predetermined number of incorrect access attempts is a security measure designed to protect against brute-force attacks and unauthorized access. Account lockout policies provide a defense mechanism against brute-force attacks where an attacker systematically attempts to guess the user's password. Locking the account after a specified number of incorrect attempts helps thwart such attacks. By limiting the number of consecutive incorrect login attempts, the likelihood of unauthorized access is reduced. Limiting the number of consecutive incorrect login attempts adds an additional layer of protection to sensitive accounts, especially those containing personal or financial information. However, while this approach has benefits, the approach also comes with certain disadvantages. As an example, a disadvantage of limiting the number of consecutive incorrect login attempts is evident in the scenario where a malicious actor intentionally triggers account lockouts, leading to a denial-of-service situation where legitimate users are unable to access their accounts. The lockout could be disruptive to the affected user and impact the availability of services. Moreover, legitimate users may find it frustrating if they are frequently locked out due to accidental mistypes or forgotten passwords. Being locked out can negatively impact the user experience, leading to dissatisfaction and potential abandonment of the service the legitimate user is attempting to access. Furthermore, in environments where users share devices (e.g., a computer shared by multiple members of a household), there is an additional risk of locking out legitimate users who use the shared device for account access.

Once an account becomes locked, getting the account unlocked again can be a cumbersome process. Depending on the account policies, the unlocking can include a user having to reauthorize himself/herself by providing multiple additional details. For instance, such details can include providing card numbers, personal information, and/or having to physically visit a location (e.g., a bank branch) in case of lockout of a bank account. As stated previously, account locking can be performed maliciously by a third party. As an example, a malicious actor can lock an account of another user if the malicious actor knows the username of the user. The malicious actor can simply attempt the required number of incorrect access attempts to cause the user to be locked out of his/her account. Furthermore, there is also ample opportunity for accidental lockouts. As an example, a device that is shared by multiple users (e.g., a desktop computer shared by a family) can create an opportunity for accidental lockouts if one user of the household accidently uses his/her password with a pre-populated username of another family member. Account lockouts can have an adverse effect on business and productivity. For the duration that the user is locked out of the account, services and products might not be consumed and/or purchased, causing harm to both users and businesses alike. An additional disadvantage is that once an account is locked, the process of getting the account unlocked again can lead to support issues and additional overhead for administrators.

Multifactor authentication (MFA) has many benefits that support the protection of online and/or electronic accounts. MFA can be implemented using various authentication methodologies, such as (i) something known to the user (e.g., a password), (ii) an object or thing the user has (e.g., a smartphone or token), or (iii) unique biometric signatures of the user (e.g., a fingerprint). The flexibility of MFA allows the enabling service/entity to choose the most suitable method based on the security needs of the service/entity and/or user preferences. Users and stakeholders often have increased confidence in systems that employ MFA, knowing that there are additional layers of security in place to protect their sensitive information. However, sometimes the additional layers of security that are intended to protect the accounts of users can cause a legitimate user to be locked out of his/her account after just a few failed attempts at entering the correct login data.

The disclosed embodiments alleviate the aforementioned issues of user account lockout by temporarily suspending access to the account following a first number of failed access attempts for responding to a first challenge. Once the account is temporarily suspended, an alternate challenge is provided to the user via use of 2FA, with a challenge answer provided to a different user device or different user account. If the user successfully answers the alternate challenge, the user is then presented with the first challenge again for an additional number of attempts to correctly enter the response to the first challenge. If the user successfully answers the first challenge, the user is then granted access to his/her account, without having to experience account lockout. As an example, an account can have a failed account access attempt limit of three (3) attempts. A user trying to access his/her account may incorrectly enter the password three times (e.g., because caps lock is on, forgetting the password, a typographical mistake, etc.). Continuing with the example, after the third incorrect password entry, instead of being automatically locked out, the user is presented with an alternate challenge, such as a two-factor authentication (2FA) challenge. This process may include sending a one-time passcode (OTP) to a mobile phone or email address associated with the user. When the user receives the OTP and enters the OTP into a user interface entry for the second challenge, the user is then presented with the first challenge again, and if the answer to the first challenge is then entered correctly, the user is given access to the account. Accordingly, disclosed embodiments still maintain the security of the account, while providing the benefits of reducing the occurrences of locking out of legitimate users by using the features of MFA as an intermediate step to reset the number of attempts to enter the correct response to the first challenge.

One or more embodiments can include an electronic device including a memory having stored thereon at least one application requiring login authentication via an account unlock module to provide access to an account. The electronic device includes a communication subsystem that comprises an interface by which the electronic device communicatively connects to, and exchanges data with, at least one second electronic device. The electronic device further includes a processor communicatively coupled to the memory and the communication subsystem, and which executes program code of the account unlock module, which causes the electronic device to detect a first number of failed access attempts for access to the account based on a first challenge. In response to the number of failed access attempts exceeding a first failed account access attempt limit, the electronic device temporarily suspends access to the account via the first challenge, and presents, to a user, an alternate challenge requiring entry of a second, different authentication response. The electronic device enables further access to respond to the first challenge only in response to receipt of a correct response to the alternate challenge.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, which enables the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

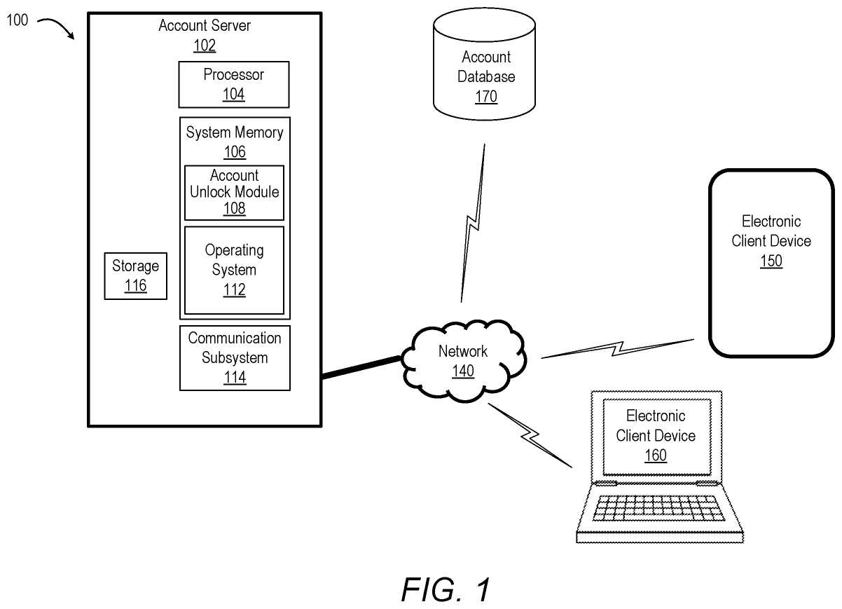

Those of ordinary skill in the art will appreciate that the hardware components and basic configuration depicted in the following figures may vary. For example, the illustrative components within electronic device 102 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as servers, smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated a diagram 100 that includes account server 102, within which various aspects of the disclosure can be implemented, according to one or more embodiments. Account server 102 is an electronic device that includes specific components that enable the device to perform functions of: detecting, by a processor of the electronic device requiring login authentication for access to a user account via an account unlock module, a first number of failed access attempts for access to the user account based on a first challenge; and in response to the first number of failed access attempts exceeding a failed account access attempt limit: temporarily suspending access to the user account via the first challenge; presenting to a user, an alternate challenge requiring entry of a second, different authentication response that is communicated via a two factor authentication (2FA) channel; and enabling further attempts to respond to the first challenge only in response to receipt of a correct response to the alternate challenge.

Account server 102 can include an account server that includes processor 104 (typically as a part of a processor integrated circuit (IC) chip), which includes processor resources such as a central processing unit (CPU), graphics processing unit (GPU), memory management unit (MMU), and/or other peripheral units. Processor 104 can interchangeably be referred to as a controller. While a single processor is shown in FIG. 1, one or more embodiments may include multiple processors to enable parallel processing, enhancing the overall performance of the server and increase the capability for the server to handle concurrent tasks. The account server 102 may be referred to herein as an ‘electronic device.’ The electronic device 102 further comprises system memory 106. System memory 106 stores data and instructions that can be used or processed by the processor 104. The system memory 106 can include the operating system (OS) 112. The operating system is a software layer that manages hardware resources, provides services to applications, and facilitates user interactions. The operating system enables the proper functioning of the server and serves as a platform for running various application modules. In one or more embodiments, the operating system 112 is a Linux distribution, Windows operating system, Unix operating system, or other suitable operating system.

The system memory 106 may include one or more application modules, including account unlock module 108. Account unlock module 108 can include instructions, that when executed by the processor 104, implement one or more features of disclosed embodiments. The features can include, but are not limited to, tasks, such as user authentication, account unlocking, and permission validation. The electronic device 102 includes a communication subsystem 114 that enables the electronic device to connect with other devices on a network. The communication subsystem 114 comprises one or more network interfaces, such as ethernet, fiber optics, or other networking technologies. These interfaces facilitate data exchange and communication between the electronic device 102 and other networked devices. The electronic device 102 can further include storage 116. The storage 116 can include storage devices to store data persistently. The storage devices may include optical storage (e.g., CD/DVD drives), magnetic storage (e.g., hard disk drives), solid-state storage (e.g., SSDs), or a combination of these. The storage 116 can be used for storing the operating system, application data, and other relevant information. System memory 106 may be a combination of volatile and non-volatile memory, such as random-access memory (RAM) and read-only memory (ROM). System memory 106 can store program code or similar data associated with an operating system 112 and/or applications such as account unlock module 108. During device operation, processor 104 processes program code of the various applications, modules, OS, and firmware, that are stored in system memory 106.

In one or more embodiments, one or more of the functions of electronic device 102 may be implemented via virtualization and/or containerization technologies. The technologies can include hypervisor-based virtualization, where one or more virtual machines (VMs) each operate as an independent server with its own operating system and allocated resources. The technologies can include container-based virtualization, where lightweight containers such as Docker containers are used, in which case each server has its own isolated file system and processes, while multiple servers may share the host operating system kernel. The technologies can include cloud-based virtualization, where one or more servers are implemented as virtual servers in the cloud to enable scalable resources.

In accordance with one or more embodiments, applications executing on electronic device 102 include, without limitation, account unlock module (AUM) 108, and/or other modules that include program instructions/code that are processed by processor 104 to cause processor 104 and/or other components of electronic device 102 to perform specific operations, as described herein. Descriptive names assigned to these modules add no functionality and are provided solely to identify the underlying features performed by processing the different modules. For example, account unlock module (AUM) 108 includes program instructions enabling device-directed procedures for unlocking an account.

In one or more embodiments, the account server 102 may perform a variety of authentication and authorization functions. These functions can include user authentication, which can include checking usernames and passwords against stored credentials. The functions can include permission management, which can include specifying which resources or actions a user is allowed or denied. The functions can include password policy enforcement. The password policy enforcement can be used to ensure that users create strong, secure passwords. In one or more embodiments, various password rules such as minimum length, complexity, and expiration may be implemented and/or enforced by the account server 102. In one or more embodiments, the password can be a pre-configured password, a token, or a biometric feature like fingerprint match or face authentication, etc. These, and other authorization functions collectively contribute to a robust security framework, ensuring that users have the appropriate access levels and permissions while maintaining the integrity and confidentiality of the system. In one or more embodiments, account server 102 may implement online accounts for multiple users. The accounts can be for a wide variety of applications, including, but not limited to, ecommerce, banking, corporate or work accounts, financial information, stock trading, education, social media, video streaming, and/or other applications.

The diagram 100 further includes a network 140 that the electronic device 102 is connected to via communication subsystem 114. In one or more embodiments, network 140 can include a local area network (LAN), wide area network (WAN), and/or the Internet. One or more electronic client devices can also be connected to network 140 to enable communication between the electronic client devices and the server, indicated as electronic device 102. The electronic client devices can include mobile phone 150, laptop computer 160, and/or other electronic client devices. In addition to the electronic client devices shown in diagram 100, other electronic client devices such as desktop computers, kiosk computers, tablet computers, smartwatches, and/or other wearable computers may also be used in one or more embodiments. Each electronic client device may include one or more processors, system memory, operating systems, user input devices, display devices, and the like, to enable a user to perform user login functions, MFA functions, and so on. In one or more embodiments, user input devices can include a physical or virtual keypad, biometric scanners, camera, etc. In one or more embodiments, electronic client device can also include various sensors that are representative of functionality to detect various physical and/or logical phenomena in relation to the electronic client device 150, such as motion, light, image detection and recognition, time and date, position, location, touch detection, sound, temperature, and so forth. Examples of the sensors include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., GPS), and so forth. In one or more embodiments, the account that the user accesses upon successful authentication may be implemented on electronic device 102, or alternatively may be implemented using an external account database 170. Thus, in one or more embodiments, some of the authentication functions may be performed on a second electronic device.

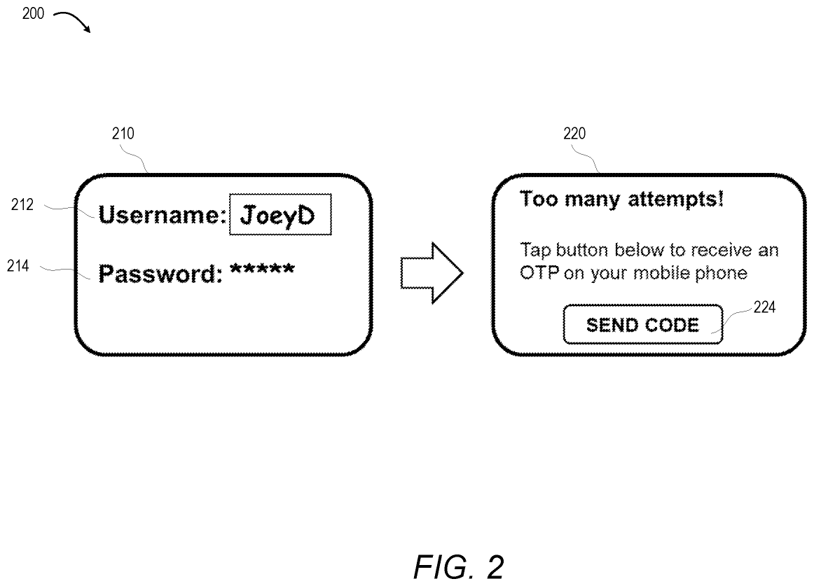

FIG. 2 illustrates a user interface sequence 200 for initiating an alternate challenge in response to a first number of unsuccessful attempts to respond to the first challenge, according to one or more embodiments. In first user interface 210, a user is prompted to enter a username at field 212 and a corresponding password at field 214. When the number of incorrect attempts exceeds a failed account access attempt limit in the first user interface 210, a second user interface 220 is displayed, which initiates an alternate challenge for the user. The user invokes button 224 which causes the electronic client device (e.g., 150 of FIG. 1) being used to access the account access portal/window/UI to send a request to the electronic device 102 for a one-time passcode as part of account lockout prevention 2FA (referred as 2FA process here onwards) process. Electronic device 102 activates the 2FA process, including generating the OTP (or other security access data) and transmitting the OTP (e.g. via text message or email) to a second user device or second user account accessible to the user.

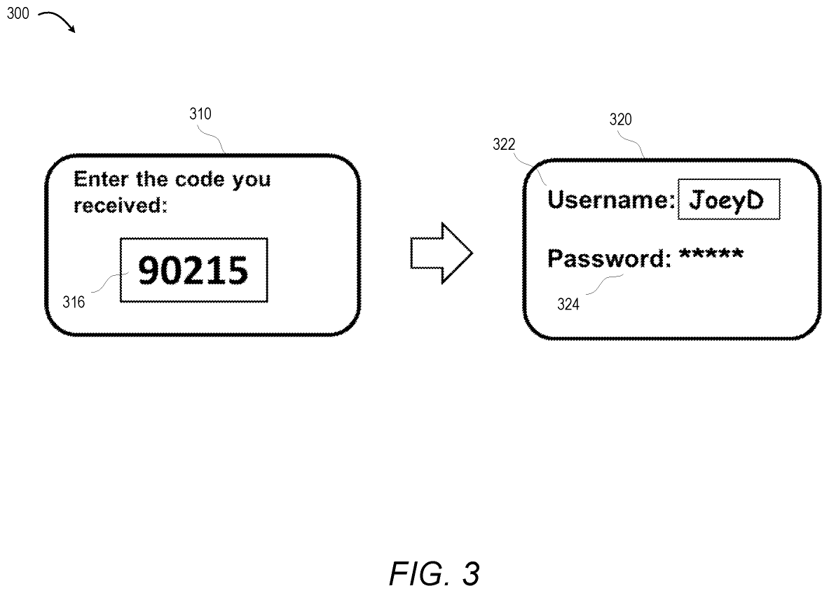

FIG. 3 illustrates a user interface sequence 300 that depicts entry of a correct response for an alternate challenge, according to one or more embodiments. In a first user interface 310, a user is prompted to enter a one-time passcode (OTP) in field 316. The OTP can be an OTP that was received (e.g., via a text notification or email) on a mobile device associated with a user. One or more embodiments can include the processor of the server generating an answer that is the correct response to the alternate challenge, and the server communicating the answer to at least one of an email address and a phone number associated with the user, or to a recovery device of the user. The recovery device can include one or more of a mobile phone, landline telephone, tablet computer, and/or other suitable recovery device. Upon the user entering the correct OTP in field 316, a second user interface 320 is displayed, that includes a field 322 for entry of a username, and field 324 for entry of a password. Thus, in one or more embodiments, the user is provided another opportunity to complete the first authentication challenge (e.g., entry of a username and corresponding password). Accordingly, if incorrect entry via a malicious actor, or accidental/incorrect input by the legitimate user causes the failed account access attempt limit to be exceeded, the user is provided another opportunity to restore access to his/her account by first using alternate authentication techniques to authenticate the user before allowing the user to attempt to enter the correct login credentials. Thus, one or more embodiments provide another opportunity for the user to answer the first authentication challenge following a temporary suspension of the access attempts. As can be seen in the sequence depicted in FIG. 2 and FIG. 3, in one or more embodiments, the first authentication challenge is not skipped or bypassed, but rather returned to upon successful completion of an alternate challenge. Accordingly, each of the intended security challenges are presented to the user, thereby maintaining the intended level of security for account access while alleviating lockout of legitimate users due to accidental and/or malicious causes.

One or more embodiment can include, in response to receiving entry of the correct response for the alternate challenge, re-presenting the first challenge to the user. In one or more embodiments, the first challenge is associated with a first part of a previously configured two-factor authentication. The embodiment further includes presenting, as the alternate challenge, a second challenge associated with a second part of the previously configured two-factor authentication, wherein the correct response is an answer to the second part of the previously configured two-factor authentication communicated via a separate communication channel. In one or more embodiments, the separate communication channel can include a cellular network, virtual private network (VPN), and/or other suitable separate communication channel.

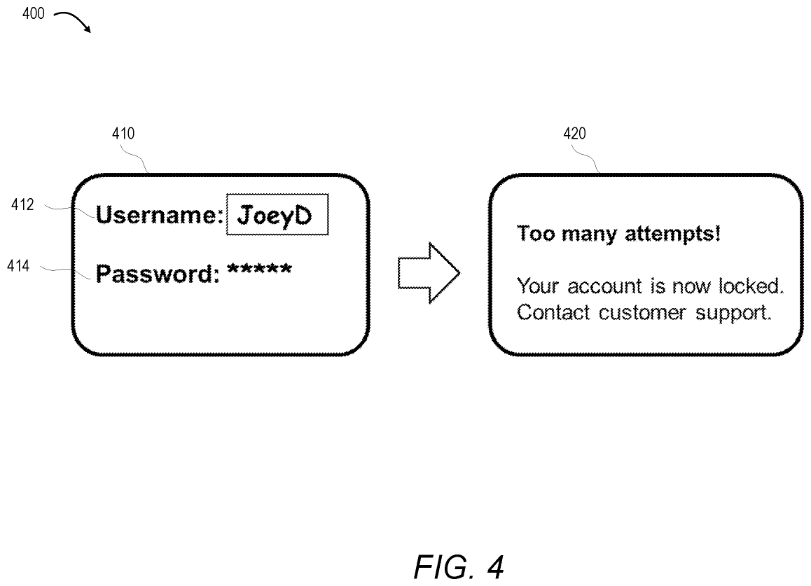

FIG. 4 illustrates a user interface sequence 400 for indicating account lockout, following a maximum number of unsuccessful access attempts, including attempts enabled post two factor authentication, according to one or more embodiments. In a first user interface 410, a user is prompted to enter a username at field 412 and a corresponding password at field 414. When the number of incorrect attempts exceeds a second failed account access attempt limit, following the entry of the correct 2FA, a second user interface 420 is displayed, which indicates that a user is locked out. In cases where a malicious actor previously entered numerous incorrect passwords corresponding to the username in field 412, the legitimate user is still presented with additional attempts to enter the correct password following entry of the 2FA. The user may still experience the user interface sequence 400 after exhausting the second number of attempts to enter the correct password, but does not automatically become locked out of the account after just a single attempt. As stated previously, a malicious lockout can cause significant inconvenience for a legitimate user, as well as adverse business impacts such as lost revenue. By delaying the lockout to after receipt of the 2FA, the current disclosure provides a higher probability that the authenticated user is the one that is presented with the additional attempts to access the account before lockout occurs.

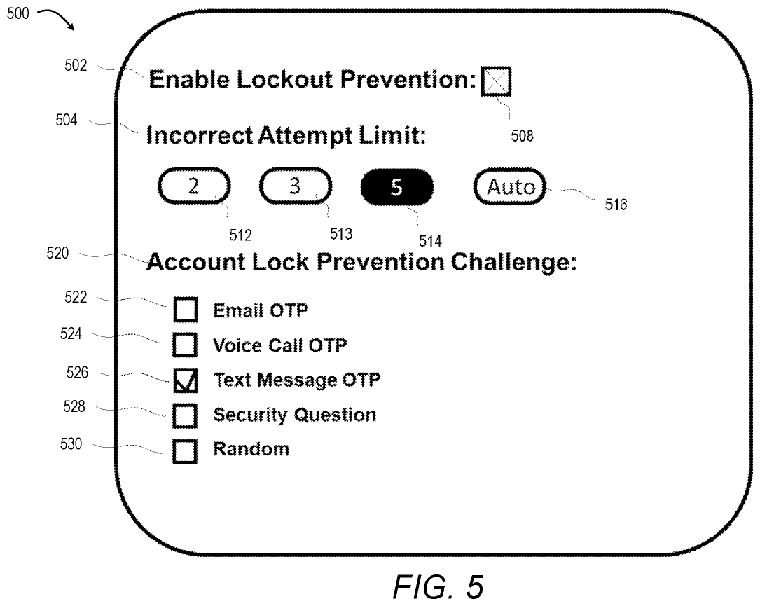

FIG. 5 illustrates an exemplary user interface 500 for configuring the account lockout prevention feature for a user account, according to one or more embodiments. In one or more embodiments, the user interface 500 may be rendered on an electronic client device, such as indicated at 150 or 160 of FIG. 1. The settings and/or options selected in user interface 500 may be communicated from the electronic client device to electronic device 102 (FIG. 1) via network 140. The user interface 500 can include an option 502 to enable the lockout prevention features of one or more embodiments. In one or more embodiments, when lockout prevention option 502 is set, such as via user selection of checkbox 508, an alternate challenge is provided to enable the user to regain account access if a first number of incorrect access attempts exceeds a predetermined threshold. The user interface 500 can further include option 504 for specifying a limit on incorrect attempts. In one or more embodiments, multiple buttons may be presented that establish a given number of incorrect attempts, such as button 512 for an incorrect attempt limit of 2, button 513 for an incorrect attempt limit of 3, or button 514 for an incorrect attempt limit of 5. In the example shown in FIG. 5, the option for 5 incorrect attempts is selected. One or more embodiments may further provide an auto option, indicated by button 516. When the auto option is enabled via button 516, the disclosed embodiments can dynamically adjust the incorrect attempt limit based on various conditions, including, but not limited to, time of day, location of the login attempt, a combination of both conditions, or alternate conditions.

The user interface 500 can include an account lock prevention challenge option 520. One or more embodiments can include receiving a user selection that specifies the type of alternate challenge that is presented. The account lock prevention challenge option 520 can include an email OTP option 522 that enables sending a one-time passcode to an email address associated with a user. The account lock prevention challenge option 520 can include a voice call OTP option 524 that enables sending a one-time passcode as audio data via a voice call to a telephone number associated with a user. The account lock prevention challenge option 520 can include a text message OTP option 526 that enables sending a one-time passcode as a text message to an electronic client device associated with a user. The account lock prevention challenge option 520 can include a security question option 528 that enables providing a security question to a user as part of an alternate authentication challenge. The account lock prevention challenge option 520 can include a random option 530 to randomly select from two or more of the options indicated at 522-528. Thus, one or more embodiments can include randomly selecting the type of alternate challenge that is presented. In the example shown in FIG. 5, the option 526 for a text message OTP is selected. Embodiments are not limited to the options indicated at 522-528, and other account lock prevention challenges are possible in disclosed embodiments.

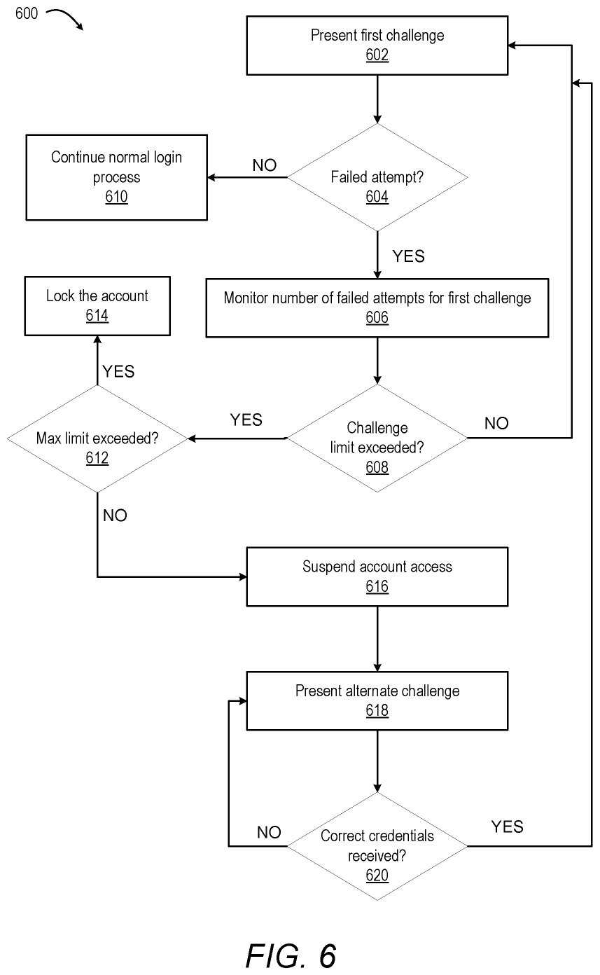

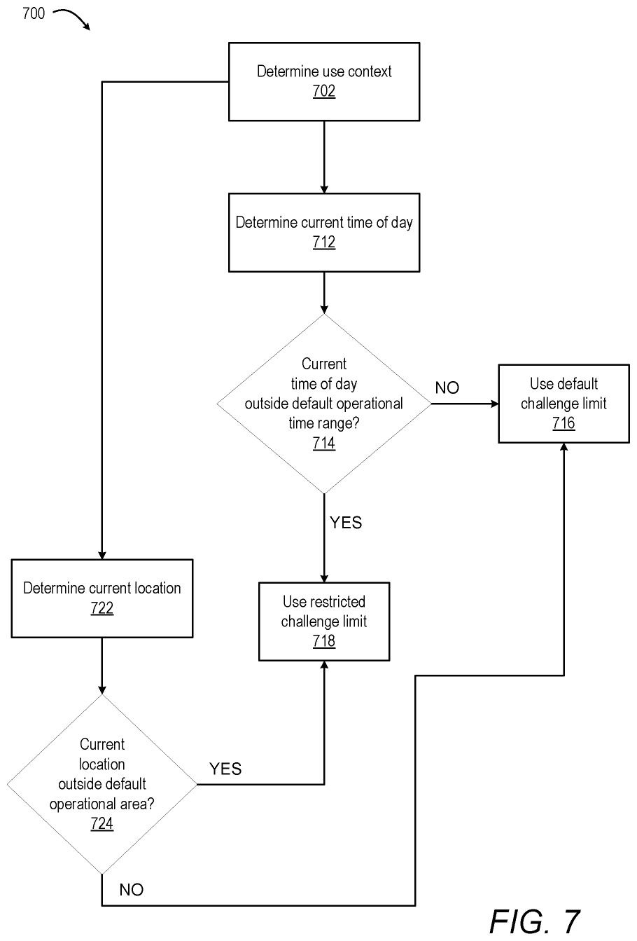

Referring now to the flowcharts presented by FIGS. 6-7, the descriptions of the methods in FIGS. 6-7 are provided with general reference to the specific components and features illustrated within the preceding FIGS. 1-5. Specific components referenced in the methods of FIGS. 6-7 may be identical or similar to components of the same name used in describing preceding FIGS. 1-5. In one or more embodiments, processor 104 (FIG. 1) configures electronic device 102 (FIG. 1) to provide the described functionality of the methods of FIGS. 6-7 by executing program code for one or more modules or applications provided within system memory 106 of electronic device 102, including account unlock module (AUM) 108 (FIG. 1).

FIG. 6 depicts a flowchart of a method 600 for account lockout prevention via use of multifactor authentication, according to one or more embodiments. The method 600 starts at block 602 with presenting a first challenge to a user. The first challenge can include, but is not limited to, a username and password entry, such as depicted at 210 of FIG. 2. The method 600 continues to block 604, where a check is performed to determine if the attempt (e.g., credential entry and comparison with the stored authenticated credential) failed. If, at block 604, it is determined that the attempt succeeded, the method 600 continues to block 610, where the normal login process continues. The normal login process can include granting access to the account, and/or one or more additional authentication steps, including, but not limited to, prompting the user for a one-time passcode, biometric identification, and/or answers to security questions.

If, at block 604, it is determined that the attempt failed, the method 600 continues to block 606, where the number of failed attempts for the first challenge is detected. The method 600 then continues to block 608, where a check is performed to determine if the challenge limit for the first challenge is exceeded. According to one or more embodiments, the challenge limit is the number of times the unsuccessful entry of the user login credential is allowed before the login to the account is suspended pending completion of an account lock prevention 2FA. If, at block 608, it is determined that the challenge limit is not exceeded, the method 600 returns to block 602, providing another opportunity for the user to respond to the first challenge. As an example, it is common for a user to accidentally mistype a password by pressing incorrect keys or inadvertently entering the password while having caps lock engaged. Furthermore, since many user interfaces obfuscate the keys being pressed (e.g., by displaying asterisks or circles in a text entry field instead of the characters the user is entering), it can be difficult for the user to know that he/she typed an incorrect password. Accordingly, one or more embodiments may provide a failed account access limit, such as three initial attempts of a total of five attempts, giving a user a few chances to answer the first challenge correctly before temporality suspending access to the account and initiating a 2FA process.

If, at block 608, it is determined that the challenge limit is exceeded, the method 600 continues to block 612, where a check is made to determine if a maximum limit of failed attempts to answer the first challenge is exceeded. In one or more embodiments, the maximum limit is larger than the challenge limit that is checked at block 608. In one or more embodiments, the maximum limit may be double the challenge limit. As an example, in one or more embodiments, the challenge limit is five and the maximum limit is 10. If, at block 612, it is determined that the maximum limit has not been exceeded, the method 600 continues to block 616, where account access is temporarily suspended. In one or more embodiments, as a result of the temporary suspension, a user interface such as 320 of FIG. 3 is presented to the user. In one or more embodiments, the user interface can enable a user to receive an emailed one-time passcode (OTP), a voice call OTP, and/or a text message OTP, or proceed to answer an alternate security challenge. The method 600 then continues to block 618, where an alternate challenge is presented. An example of an alternate challenge is shown in user interface 410 of FIG. 4. In one or more embodiments, another alternate challenge may be presented instead of, or in addition to, an OTP-based challenge. The alternate challenge may include, but is not limited to, a security question challenge, a biometric challenge (e.g., facial identification, fingerprint identification, iris scan, etc.), and/or other type of alternate challenge. The method 600 then continues to block 620. If at block 620, it is determined that the correct credentials to the alternate challenge presented at block 618 are received, the method 600 returns to block 602, providing another opportunity for the user to respond to the first challenge. If, at block 620, it is determined that the correct credentials to the alternate challenge presented at block 618 are not received, the method 600 returns to block 618, providing another opportunity for the user to respond to the alternate challenge. One or more embodiments can include presenting a first challenge that is associated with a first part of a multi-factor authentication, and further comprising presenting a third challenge that is different from a second challenge associated with a second part of the multi-factor authentication. The alternate challenge can be a third challenge. In one or more embodiments, the alternate challenge can include a request for a one-time passcode (OTP), a security question, a puzzle, or other suitable challenge type. In some instances, an answer to an alternate challenge such as an OTP may be delayed, or not arrive due to network congestion or issues. One or more embodiments enable the retry of the alternate challenge process to accommodate such instances.

If, at block 612, it is determined that the maximum limit has been exceeded, the method 600 continues to block 614 where the account is fully locked. As a result of the account being fully locked, a user interface such as 220 of FIG. 2 may be presented to the user. Accordingly, in one or more embodiments, even with the alternate challenge, if the first challenge fails too many times, the account is ultimately locked, thereby preserving security of the account. In one or more embodiments, the number of failed attempts detected at block 606 is reset to zero once there is a successful response to the first challenge. In other words, in one or more embodiments, the number of failed attempts is maintained until there is a successful response to the first challenge. In this way, if a malicious actor locks the account with multiple incorrect attempts on a given day, and the legitimate user attempts access on a later day, the legitimate user is directed to block 618, where the alternate challenge is presented. Thus, disclosed embodiments maintain the security put in place by various authentication steps of a MFA process, while reducing the occurrences of lockouts of legitimate users.

FIG. 7 depicts a flowchart of a method 700 for establishing a failed account access attempt limit based on use context, according to one or more embodiments. In one or more embodiments, the use context can include a current time of day, a geographical location, and/or other criteria. In one or more embodiments, method 700 may be invoked when the auto option (516 of FIG. 5) is enabled. The method 700 starts at block 702 with determining a use context. The use context can be established as part of a user profile, set by a service provider, and/or other suitable techniques. The method 700 can continue with determining a current time of day at block 712. The time of day may be determined in UTC time, local time, or other suitable time zone. The method 700 continues to block 714, where a check is made to determine if the current time of day is outside of a default operational time range. If, at block 714, it is determined that the current time of day is not outside of the default operational time range, then the method 700 proceeds to block 716, where a default challenge limit is used when performing the method 600 depicted in FIG. 6. If, at block 714, it is determined that the current time of day is outside of the default operational time range, then the method 700 proceeds to block 718, where a restricted challenge limit is used when performing the method 600 depicted in FIG. 6. One or more embodiments can include: obtaining a current time of day; comparing the current time of day with a previously established default operational time range for allowing more than a first threshold number of incorrect access attempts to the user account; and establishing the failed account access attempt limit based on the current time of day being outside of the previously established default operational time range.

As an example, a default operational time range for using an ecommerce application may be defined as 7:00 PM to 11:00 PM daily. In one or more embodiments, the default operational time range can be user-defined, established by a service provider, automatically inferred from past user activity, and/or identified using other suitable techniques. If a failed access attempt limit is exceeded (e.g., YES for block 608 in FIG. 6), during the time range between 7:00 PM to 11:00 PM, then a default failed access limit of five attempts may be used for carrying out the steps of method 600 of FIG. 6. Conversely, if a failed access attempt limit is exceeded (e.g., YES for block 608 in FIG. 6), outside of the time range between 7:00 PM to 11:00 PM, then a restricted failed access limit of three attempts may be used for carrying out the steps of method 600 of FIG. 6. Accordingly, one or more embodiments can set reduced retry limits during failed access attempts that occur outside of a default operational time range, thereby providing increased security.

Alternatively, or additionally, the method 700 may continue to block 722 for determining a current location for an electronic device. The determining of a current location can be based on an IP address used to attempt logging into an account, and/or other suitable criteria. The method 700 continues to block 724, where a check is made to determine if the current location is outside of a default operational area. In one or more embodiments, the location can be retrieved from electronic client device through use of sensors like GPS. If, at block 724, the current location of an electronic device is outside the default operational area, the method 700 continues to block 718, where a restricted challenge limit is used when performing the method 600 depicted in FIG. 6. If, at block 724, the current location of an electronic device is not outside the default operational area, the method 700 continues to block 716, where a default challenge limit is used when performing the method 600 depicted in FIG. 6. As an example, a default operational area can be a country, such as the user's home country. When the device is used in a different country, the restricted challenge limit may be used.

One or more embodiments can include a computer program product comprising a non-transitory computer readable medium having program instructions that when executed by a processor of an electronic device, configure the electronic device to perform functions comprising: detecting a number of failed access attempts for access to an account based on a first challenge; and in response to the number of failed access attempts exceeding a failed account access attempt limit: temporarily suspending access to the account via the first challenge; presenting to a user, an alternate challenge requiring entry of a second, different authentication response; and enabling further access to respond to the first challenge only in response to receipt of a correct response to the alternate challenge.

As can now be appreciated, the various disclosed embodiments provide techniques to reduce occurrences of account lockout for legitimate users, by utilizing the security advantages of multifactor authentication, and maintaining automatic lockout procedures that take effect after too many failed access attempts. For a user, being locked out of an account, whether it is an email account, social media account, or any other online platform, can have several significant disadvantages. The most immediate disadvantage is the loss of access to the account. The loss of access means the user cannot retrieve or send messages, access important information, and/or use services associated with that account. Moreover, dealing with the process of account recovery can be inconvenient and frustrating. Depending on the platform, account recovery may involve multiple verification steps, waiting periods, and communication with customer support. For business or work-related accounts, being locked out can disrupt the productivity and workflow for a user. This is especially true if the account is linked to collaboration tools, project management platforms, or other work-related applications. Disclosed embodiments mitigate the risk of a legitimate user getting locked out of his/her accounts, thereby improving the user experience and productivity for users.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a memory having stored thereon at least one application requiring login authentication via an account unlock module to provide access to an account;
a communication subsystem that comprises an interface by which the electronic device communicatively connects to, and exchanges data with, at least one second electronic device; and
a processor communicatively coupled to the memory and the communication subsystem, and which executes program code of the account unlock module, which causes the electronic device to:
detect a number of failed access attempts for access to the account based on a first challenge; and
in response to the number of failed access attempts exceeding a failed account access attempt limit:
temporarily suspend access to the account via the first challenge;
present, to a user, an alternate challenge requiring entry of a second, different authentication response; and
enable further access to respond to the first challenge only in response to receipt of a correct response to the alternate challenge.

2. The electronic device of claim 1, wherein further, the processor, in response to receiving entry of the correct response for the alternate challenge, re-presents the first challenge to the user.

3. The electronic device of claim 1, wherein further, the processor:
generates an answer that is the correct response to the alternate challenge; and
communicates the answer to at least one of an email address and a phone number associated with the user, or a recovery device of the user.

4. The electronic device of claim 3, wherein the first challenge is associated with a first part of a previously configured two-factor authentication, and wherein to present the alternate challenge to the user, the processor configures the electronic device to present, as the alternate challenge, a second challenge associated with a second part of the previously configured two-factor authentication, wherein the correct response is an answer to a second part of the previously configured two-factor authentication communicated via a separate communication channel.

5. The electronic device of claim 1, wherein the first challenge is associated with a first part of a two-factor authentication, and wherein to present the alternate challenge to the user, the processor configures the electronic device to present a third challenge that is different from a second challenge associated with a second part of the two-factor authentication.

6. The electronic device of claim 5, wherein to present the alternate challenge, the processor presents a challenge of a type that includes one or more of: an emailed one-time passcode (OTP), a voice call OTP, and a text message OTP.

7. The electronic device of claim 6, wherein the processor randomly selects the type of third challenge that is presented, and wherein the correct response is an answer to the second part of the two-factor authentication communicated via a separate communication channel.

8. The electronic device of claim 1, wherein the processor:
obtains a current time of day;
compares the current time of day with a previously established default operational time range for allowing more than a first threshold number of incorrect access attempts to the account; and
establish the failed account access attempt limit based on the current time of day being outside of the previously established default operational time range.

9. A method comprising:
detecting, by a processor of an electronic device requiring login authentication for access to a user account via an account unlock module, a number of failed access attempts for access to the user account based on a first challenge; and
in response to the number of failed access attempts exceeding a failed account access attempt limit:
temporarily suspending access to the user account via the first challenge;
presenting to a user, an alternate challenge requiring entry of a second, different authentication response; and
enabling further access to respond to the first challenge only in response to receipt of a correct response to the alternate challenge.

10. The method of claim 9, further comprising, in response to receiving entry of the correct response for the alternate challenge, re-presenting the first challenge to the user.

11. The method of claim 9, further comprising:
generating an answer that is the correct response to the alternate challenge; and
communicating the answer to at least one of an email address and a phone number associated with the user, or a recovery device of the user.

12. The method of claim 9, wherein the first challenge is associated with a first part of a previously configured two-factor authentication, and further comprising presenting, as the alternate challenge, a second challenge associated with a second part of the previously configured two-factor authentication, wherein the correct response is an answer to the second part of the previously configured two-factor authentication communicated via a separate communication channel.

13. The method of claim 9, wherein the first challenge is associated with a first part of a two-factor authentication, and further comprising presenting a third challenge that is different from a second challenge associated with a second part of the two-factor authentication.

14. The method of claim 13, wherein the alternate challenge comprises a challenge of a type that includes one or more of: an email one-time passcode (OTP), a voice call OTP, and a text message OTP.

15. The method of claim 14, further comprising randomly selecting the type of alternate challenge that is presented.

16. The method of claim 14, further comprising receiving a user selection that specifies the type of alternate challenge that is presented.

17. The method of claim 9, further comprising:
obtaining a current time of day;
comparing the current time of day with a previously established default operational time range for allowing more than a first threshold number of incorrect access attempts to the user account; and
establishing the failed account access attempt limit based on the current time of day being outside of the previously established default operational time range.

18. A computer program product comprising a non-transitory computer readable medium having program instructions that when executed by a processor of an electronic device, configure the electronic device to perform functions comprising:
detecting a number of failed access attempts for access to an account based on a first challenge; and
in response to the number of failed access attempts exceeding a failed account access attempt limit:
temporarily suspending access to the account via the first challenge;
presenting to a user, an alternate challenge requiring entry of a second, different authentication response; and
enabling further access to respond to the first challenge only in response to receipt of a correct response to the alternate challenge.

19. The computer program product of claim 18, further comprising program instructions for: in response to receiving entry of the correct response for the alternate challenge, re-presenting the first challenge to the user.

20. The computer program product of claim 18, wherein the first challenge is associated with a first part of a previously configured two-factor authentication, and further comprising program instructions for: presenting, as the alternate challenge, a second challenge associated with a second part of the previously configured two-factor authentication, wherein the correct response is an answer to a second part of the previously configured two-factor authentication communicated via a separate communication channel.
